(19) United States
(12) Patent Application Publication
(10) Pub. No.: US 2013/0221673 A1
(43) Pub. Date: Aug. 29, 2013

(54) POWER GENERATING UNIT

(71) Applicant: Ping-Chih Liu, Taipei (TW)

(72) Inventor: Ping-Chih Liu, Taipei (TW)

(21) Appl. No.: 13/402,874

(22) Filed: Feb. 23, 2012

(51) Int. Cl. F03B 13/08; F03B 17/04

(52) U.S. Cl. 290/54; 415/916

(57) ABSTRACT

A power generating unit based on self-generating energy sources, which is implemented by combination of the pool, water wheel, water guide channel, motor, waterproofing motor housing, water compression tube, water propeller and power generator as well as electrical control box; with this power generating unit, a small portion of self-generating energy could be applied to power generation, without need of additional fuel or energy sources; hence this is a weatherproof, most cost-effective and environmental-friendly power generating unit with longer service life and smaller space as well as minimum cost of protection, maintenance and management.

### BACKGROUND OF INVENTION

1. Field of the Invention

The present invention relates generally to a power generating unit, and more particularly to one which could use self-generating energy sources.

2. Description of Related Art

There are currently available with many modes of power generation from heavy oil, coal, nuclear energy, hydraulic power, solar energy and wind power, etc. However, either of said power generation has shortcomings or instability in the power generation.

Hence, the utility model is to provide a stable power generating unit that can use self-generating energy sources.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### DETAILED DESCRIPTION OF THE INVENTION

The utility model is implemented by a power generating unit, which comprising:

a pool filled with water;

at least a water wheel in the pool;

a water guide channel placed into the water under the water wheel, with an inlet tube at its front end and a water outlet at its rear end; water can be guided from the inlet tube to the water guide channel, so as to impact the water wheel and then flow into the pool from the water outlet;

at least a motor set in the pool;

a waterproofing motor housing set in the pool and capable of separating water from the motor;

a water compression tube located between the water guide channel and the motor, with an inlet and an outlet connected with the inlet of the inlet tube, and the diameter shrunk from the inlet to the outlet;

a water propeller located between the motor and the water compression tube, with its one end coupled with the axle center of the motor, and the other end provided with a rotary fan set in the inlet of the water compression tube;

a power generator located out of the pool at one side of the water wheel's axle center; and

an electrical control box located out of the pool and electrically connected with the motor and the power generator.

Although the invention has been explained in relation to its preferred embodiment, it is to be understood that many other possible modifications and variations can be made without departing from the spirit and scope of the invention as hereinafter claimed.

### BRIEF DESCRIPTION OF THE DRAWINGS

FIG. 1: a perspective view of the utility model.

FIG. 2: I-I sectional view of FIG. 1.

FIG. 3: II-II sectional view of FIG. 1.

FIG. 4: a top view of the utility model.

FIG. 5: an exploded perspective view of the water wheel.

FIG. 6: an exploded perspective view of the water guide channel, water compression tube and water propeller.

FIG. 7: a sectional view of the water compression tube in collaboration with a water propeller.

FIG. 8: a perspective view of the water compression tube in collaboration with a water propeller.

FIG. 9: a sectional view of the water compression tube in collaboration with two water propellers.

FIG. 10: a perspective view of the water compression tube in collaboration with two water propellers.

FIG. 11: a sectional view of the water compression tube in collaboration with three water propellers.

FIG. 12: a perspective view of the water compression tube in collaboration with three water propellers.

FIG. 13: a partially enlarged view of the water wheel in collaboration with the first breakwater.

FIG. 14: a partially enlarged view of the water wheel in collaboration with the second breakwater.

FIG. 15: a partially enlarged view of the water wheel in collaboration with the third breakwater.

FIGS. 16˜17: a schematic sectional view of the utility model.

FIG. 18: a sectional view of the utility model when the float switch is actuated.

FIG. 19: a top view of the utility model when two sets are used.

FIG. 20: a sectional view of FIG. 19 implemented in collaboration with the cover body.

FIG. 21: a top view of the utility model when several sets are used.

FIG. 22: a sectional view of the utility model when a special water guide channel is implemented.

### SUMMARY OF THE INVENTION

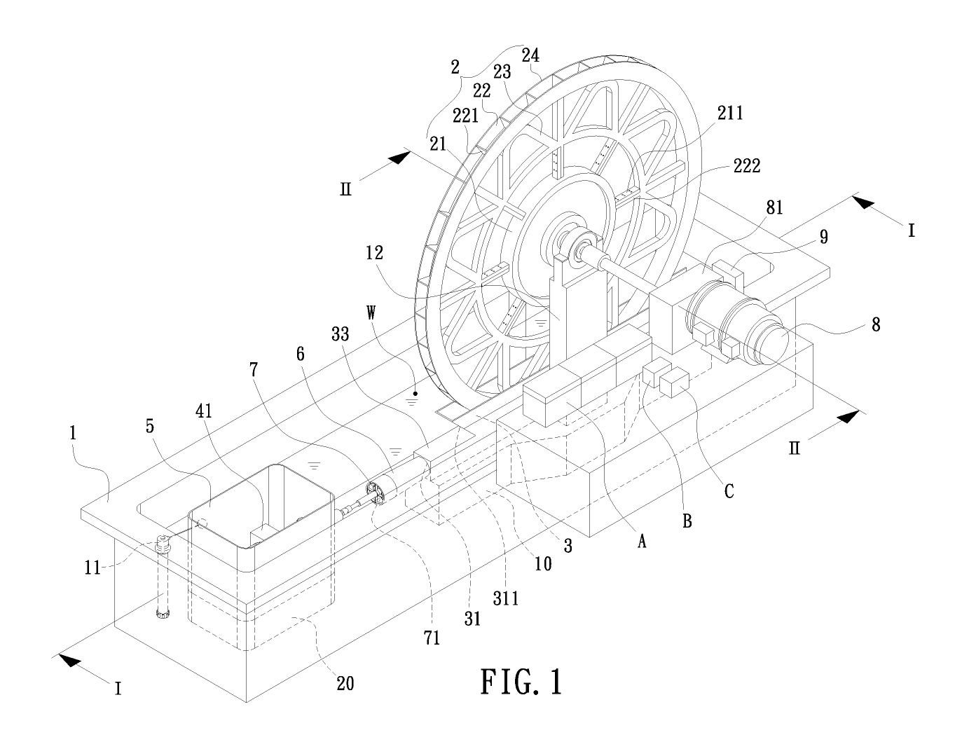

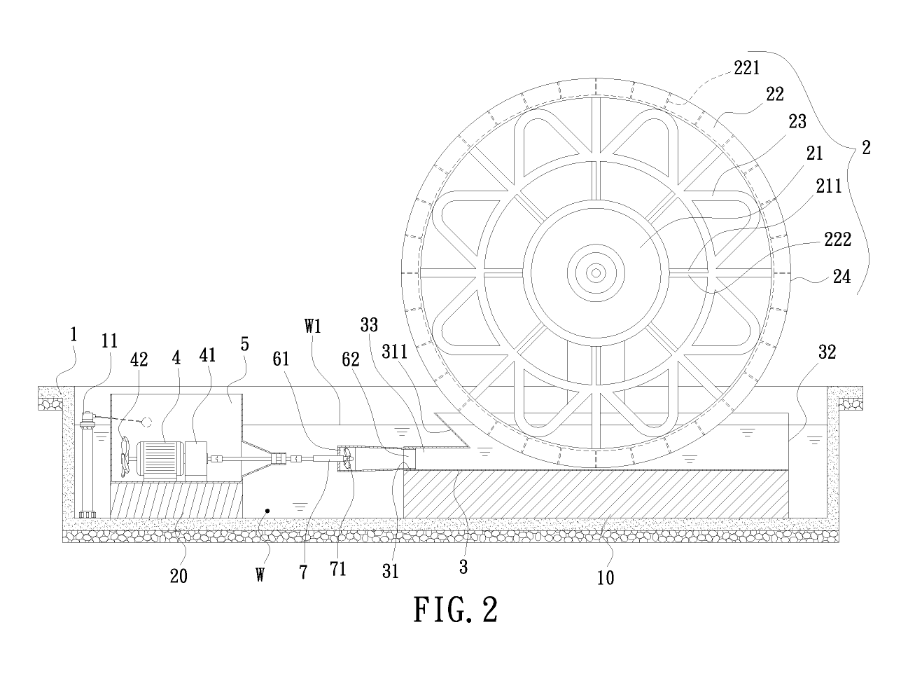

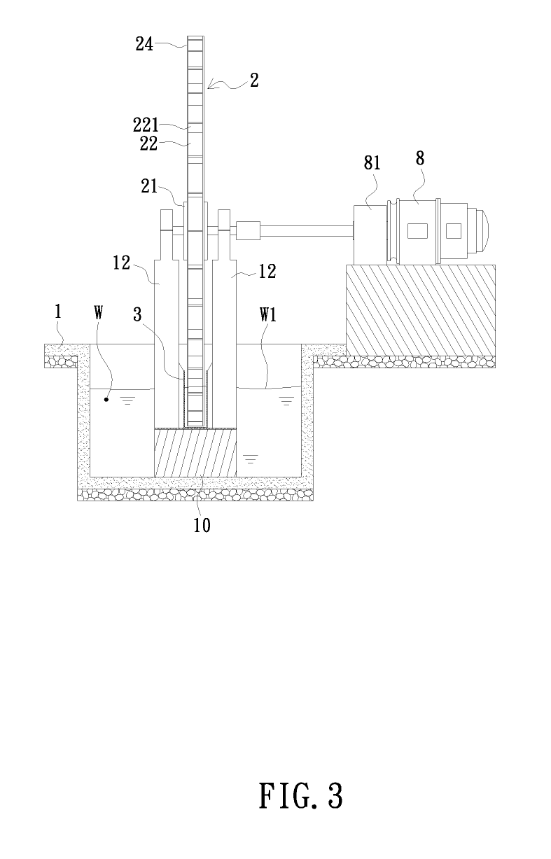

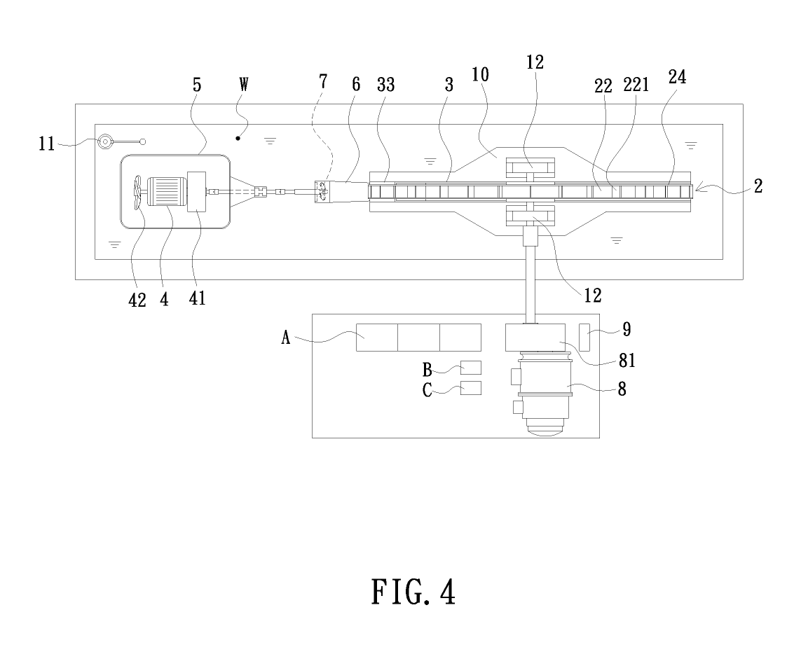

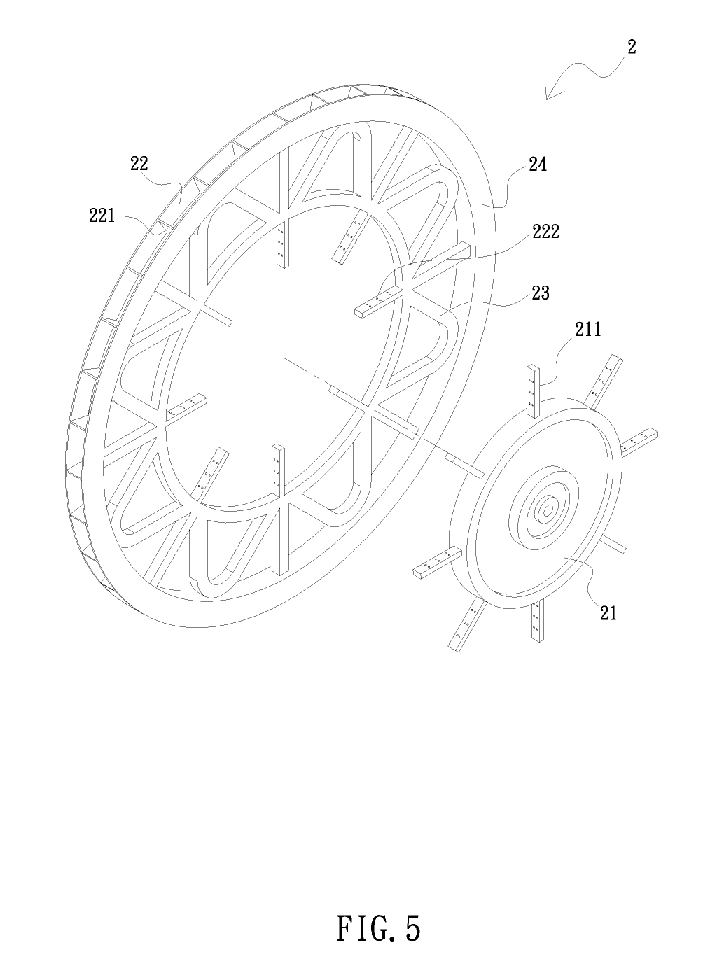

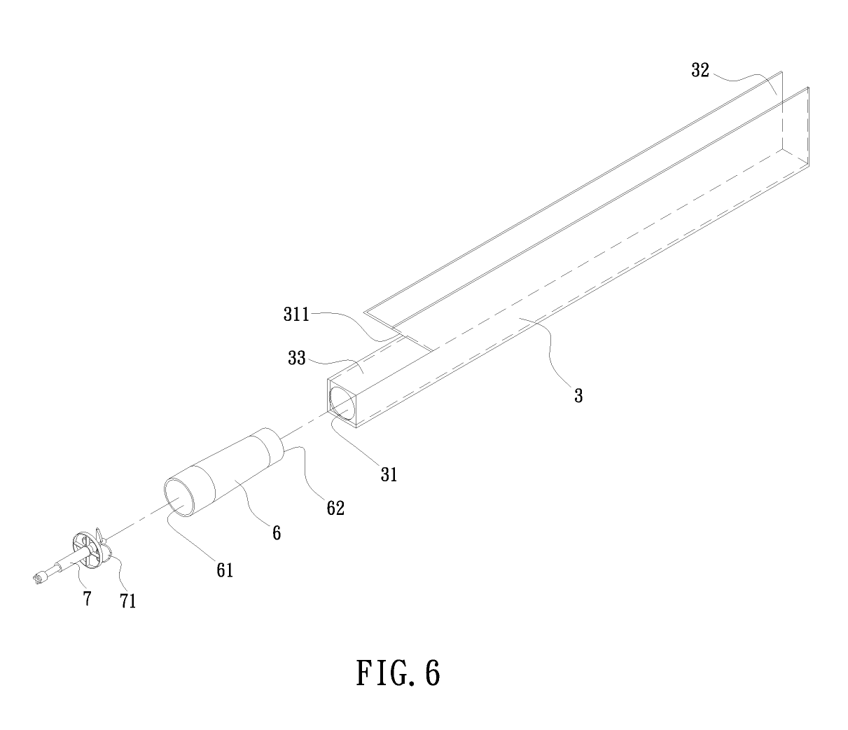

The present invention is described in detail with reference to the accompanying drawings:
FIGS. 1˜6 depict a power generating unit that could use self-generating energy sources, which comprising:

a pool 1 filled with water W;

at least a water wheel 2 in the pool 1, and its lower end set below said water surface W1,

a water guide channel 3 placed into the water 2 under the water wheel 2, with an inlet tube 33 extended at its front end and an open water outlet 32 at its rear end; water W can be guided from the inlet tube 33 to the water guide channel 3, so as to impact the water wheel 2 and then flow into the pool 1 from the water outlet 32;

at least a motor 4 set in the pool 1 and kept at a spacing with said inlet tube 33;

a waterproofing motor housing 5 set in the pool 1 around the motor 4 and capable of separating water W from the motor 4;

a water compression tube 6 located between said inlet tube 33 and the motor 4, with its one end provided with an inlet 61 set opposite to the motor 4 and the other end with an outlet 62 connected with the inlet 31 of the inlet tube 33, and the diameter shrunk from the inlet 61 to the outlet 62;

a water propeller 7 located between the motor 4 and the water compression tube 6, with its one end set far away from the inlet 61 and coupled with the axle center of the motor 4, and the other end provided with a rotary fan 71 set in the inlet 61; water W is guided from the inlet 61 by the accelerated rotation of the water propeller 7, and then discharged from the outlet 62;

a power generator 8 located out of the pool 1 at one side of the water wheel 2's axle center and also coupled with the axle center; and

an electrical control box 9 located out of the pool 1 and electrically connected with the motor 4 and the power generator 8 to control their operation.

With high-speed rotation of the motor 4, the utility model permits to drive the water propeller 7, and push water W into the water compression tube 6 and into the water guide channel 3; the flow of water W is accelerated due to high rotation speed of the water propeller 7 (e.g. over 2000/rpm).

Secondly, the water guide channel 3 resembles like a ditch of small sectional area, so the flow of incoming water could be accelerated. Similarly, after the water propeller 7 is rotated at high-speed, water W is pushed into the water guide channel 3, so that water flow is accelerated to yield high-speed impact to push the rotation of the water wheel 2 and generate high torsion, thus driving the power generator 8 for power generation.

Thirdly, the operation or shutdown of the utility model could be operated simply. For example, if there is a power generating unit of 50 kw and the other one of 1000 kw in a plant, the power generating unit of 1000 kw could be used in daytime, and that of 50 kw used in nighttime alternatively. Not only could this prolong the service life, but it also improves the utilization of energy.

In addition, water W in the pool 1 of the utility model refers to circulating water that's replaced every 3˜4 months, or supplemented automatically, depending on the conditions of evaporation, to maintain the water level.

Moreover, the torque of the water wheel 2 is related to the generating capacity and determined by the diameter of water wheel 2, width and depth of the water guide channel 3 as well as the amount of retaining water and rotating speed. Therefore, the utility model could be applied broadly since it can provide a generating capacity including: 50 kw, 110 kw, 150 kw, 200 kw, 300 kw, 500 kw, 1000 kw and 2000 kw only through market-oriented adjustment and design.

As mentioned above, a reduction gearbox 41 for the motor 4 is set between said motor 4 and water propeller 7, whilst an acceleration gearbox 81 for the water wheel 2 is set between said water wheel 2 and power generator 8.

As mentioned above, the motor 4 for driving the water propeller 7 presents minimum power consumption. Assuming that: a motor 4 of 6000/rpm is connected with the reduction gearbox 41, the torque could be tripled when decelerating to 2000/rpm, so only 10 kw motor could be used to realize the torque of 30 kw; if such torque is used to rotate the water propeller 7 and push water W, the torque of different strength could be generated to drive the power generator 8 up to 5000 kw, depending on the diameter of the water wheel 2. So, this is an energy-saving power generation mode of extremely high power generation efficiency.

As mentioned above, a water wagon platform 10 is set below the water guide channel 3 for positioning purpose; a motor platform 20 for positioning of the waterproofing motor housing is set at bottom of said waterproofing motor housing. Through the water wagon platform 10 and motor platform 20, the water wheel 2 and the motor 4 could run stably without failures arising from vibration.

As mentioned above, the power generator 8 is a low-speed one; both of the power generator 8 and the electrical control box 9 are electrically connected with at least a big-sized battery set A, at least a charger B and at least a transformer set C. More efficient power generation could be implemented by the low-speed power generator; and the combination of big-sized battery set A, charger B and transformer set C enables to store efficiently the power for subsequent power generation.

As mentioned above, the water wheel 2 comprising:

a disk body 21 located at the axle center and coupled with the power generator 8, with several mating columns 211 set circumferentially;

an external wheel 24 set around the disk body 21, butt-jointed with the mating columns 211 of said disk body 21 by several mating columns 222, and segregated into several water-retaining grooves 22 by several breakwaters 221; and

clamp plates 23 screwed and connected between two mating columns 211, 222 and water-retaining groove 22.

With said assembly, this could improve the overall safety, reduce the manufacturing difficulty and cost of the water wheel 2, and enhance the overall strength while preventing abnormal rotation or even breakup of the water wheel 2 due to water impact.

In said pool 1, a float switch 11 for monitoring and controlling the water level W1 is set; when water level in the pool drops to the lower limit (e.g.: 3 cm) after natural evaporation, the float switch 11 will automatically make up water; when the water level reaches the upper limit, no water is added, such that a proper amount of water W is maintained in the pool.

A water stop board 311 capable of avoiding spillover of W is located at front end of said water guide channel 3 correspondingly to the tangential direction of the water wheel 2; and the inlet tube 33 is set under the front of the water stop board 311. Through such setting, reverse flow of water W in the water guide channel 3 against overall operation could be prevented, thus reducing the impact of reverse water flow on the water wheel 2.

The rear end of said motor 4 is coupled with a radiator fan 42 for accelerating heat radiation of the motor 4, helping to ensure durable operation and prevent failure of the motor 4 arising from overheating in an enclosed environment.

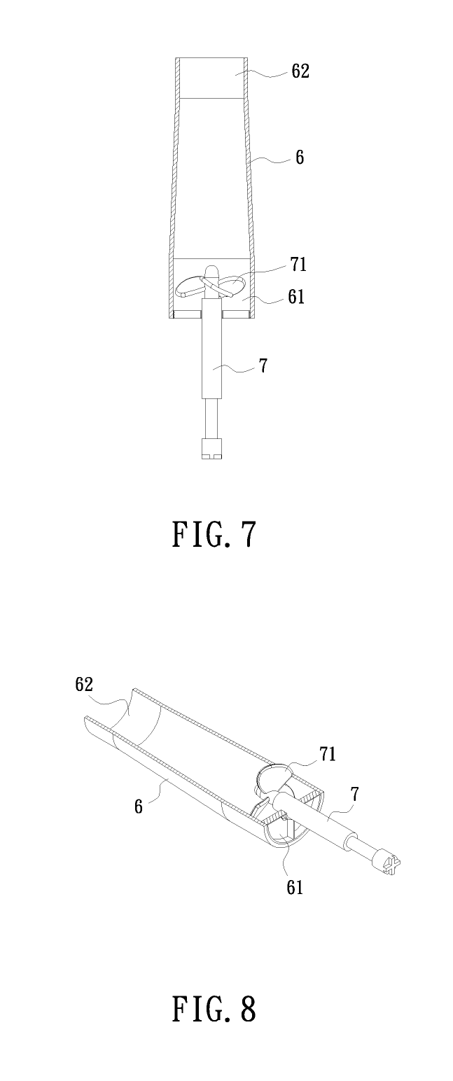

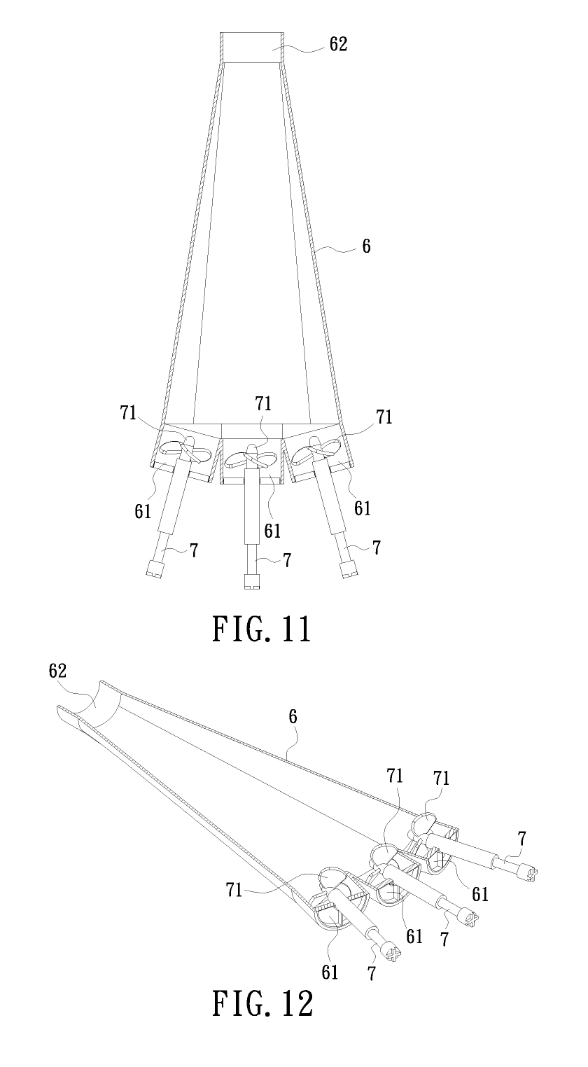

FIGS. 7, 9, 11, as well as 8, 10 and 12 depict the application views of the water compression tube of the utility model in collaboration with 1, 2 or 3 water propellers.

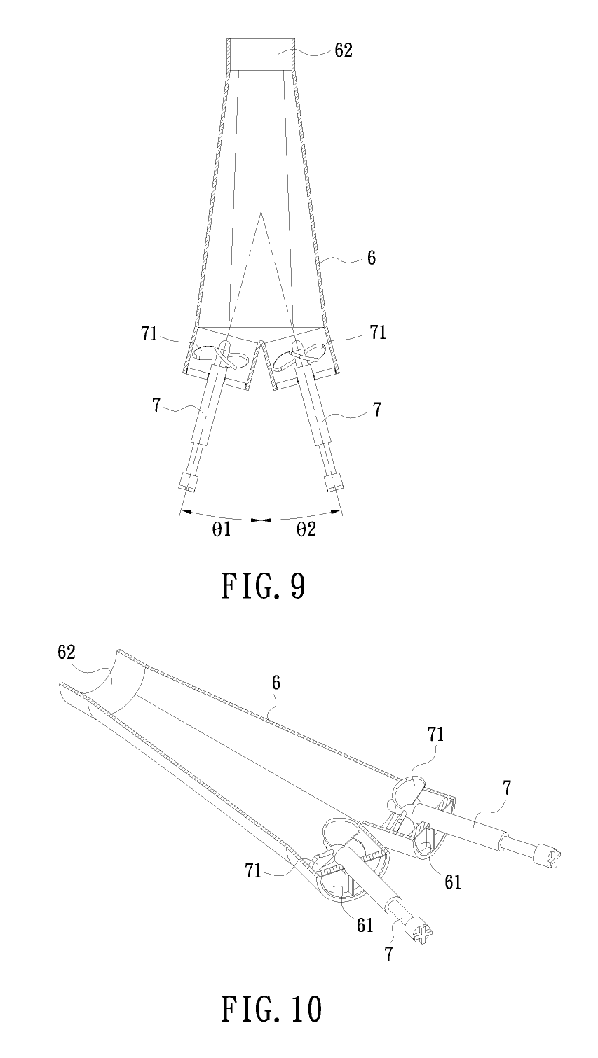

As disclosed in the figures, if there are two or more water propellers 7, they're set separately at a deflection angle with the axle center of the water compression tube 6, and the deflection angles for the water propeller 7 must not the same. Referring to FIG. 9, the deflection angles θ1, θ2 for two water propellers 7 are the same, or varied if necessary. Through this setting, it is possible to increase the quantity of the water propellers 7, improve the velocity and impulsion of water W, thus enhancing the power generation efficiency to provide a solution with different power generating capacities.

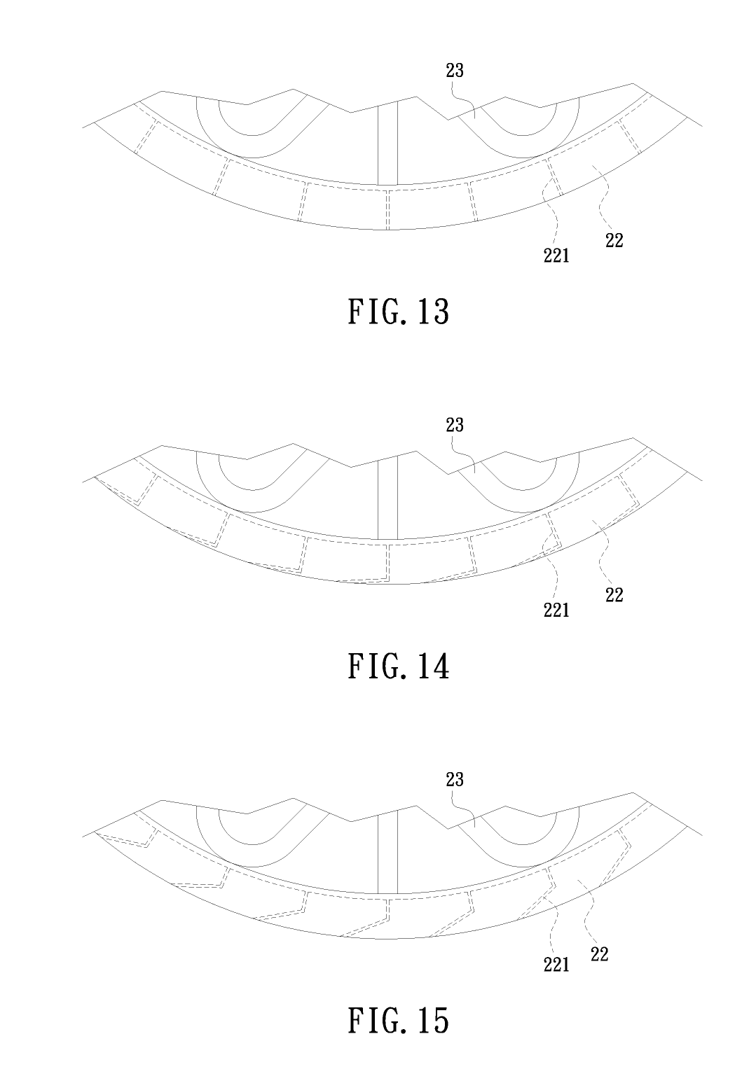

FIGS. 13, 14, 15 depict application views of three breakwaters unique to the water wheel, wherein the breakwater 221 is designed into either of flat (FIG. 13), L-shaped (FIG. 14) or [symbol] -shaped (FIG. 15) patterns. The water wheel 2 has various operating efficiencies by setting of different shapes of breakwaters 221. Secondly, the breakwater 221 could be adapted to the water wheel 2 of different dimensions for optimized operation.

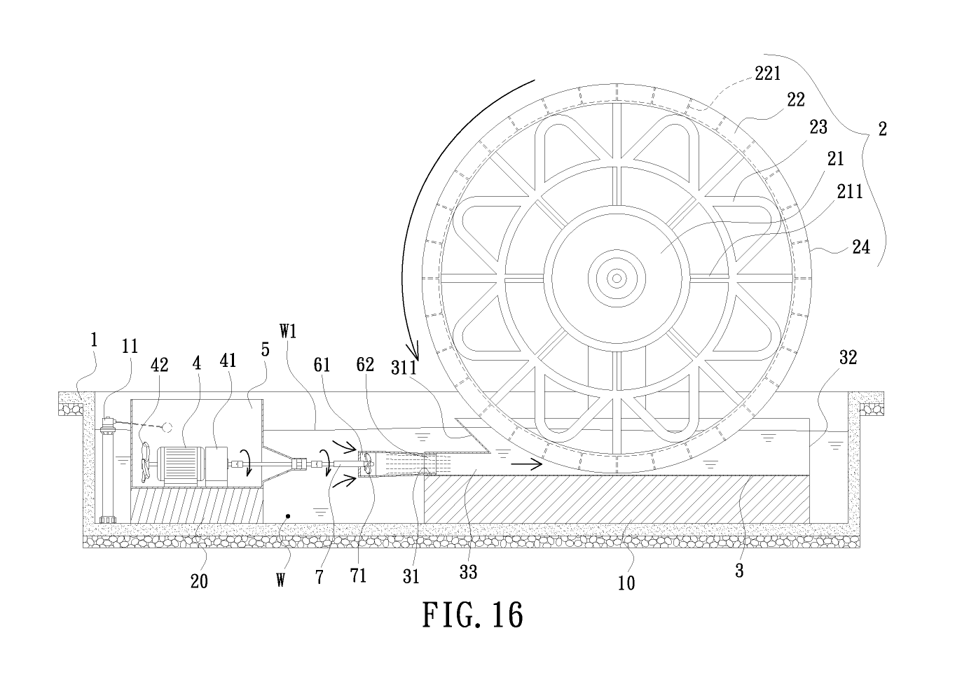

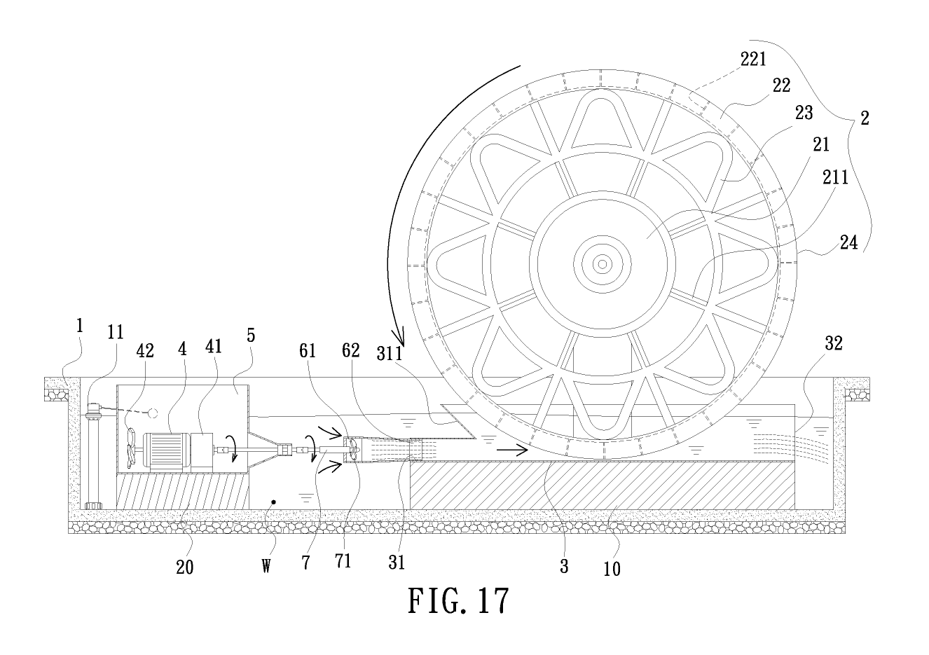

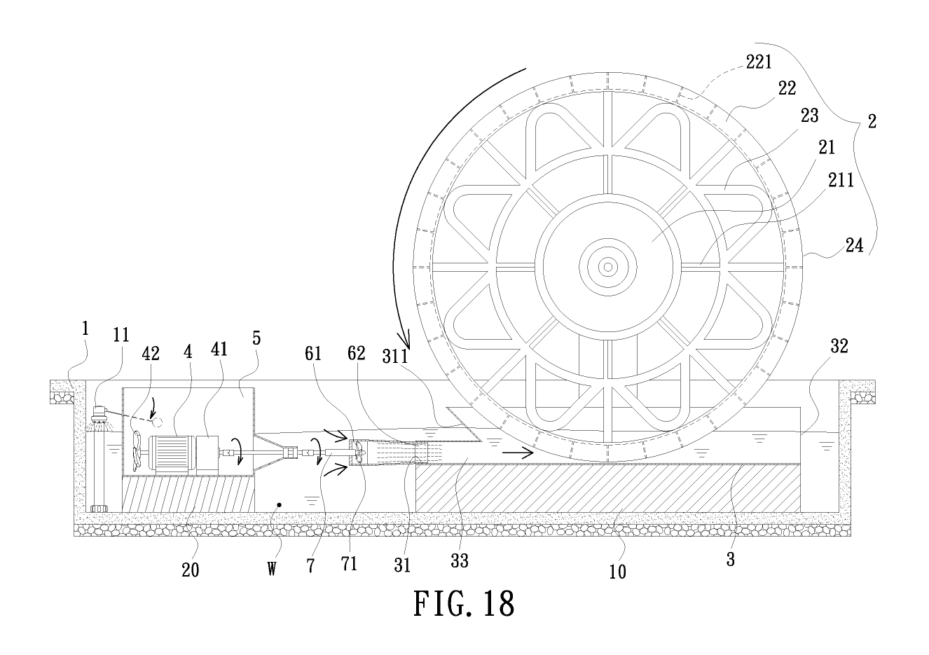

FIGS. 16, 17 depict schematic views of the utility model, and FIG. 18 depicts an actuating view of the float switch. The biggest advantage of the utility model lies in that, a small portion of self-generating energy could be applied to continuous operation for stable power generation, without need of fuel or additional energy sources.

The second advantage lies in its small space without the restrictions of terrain and site, for example, a unit can be installed on a vacant lot of 60 m². Firstly, a pool 1 is excavated, into which a water wagon platform 10 and a motor platform 20 are set; next, a waterproofing motor housing 5, motor 4 and water wheel 2 are installed, followed by the installation of power generator 8 within approx. 30˜40 days. In this way, the erection cost of lines can be saved, and the power generated can be used locally since such utility model can be installed at any site where power supply is required. Moreover, water W in the pool 1 can be circulated, or automatically supplied through the float switch 11 when the water level drops due to natural evaporation.

The third advantage lies in that, the power generating unit has higher efficiency without being restricted by the environment and climate, while different quantities of power, e.g.: 50 kw˜5000 kw, can be planned; besides, one, two or more power generating units can be arranged depending on the dimension of the pool. Except for the noise of water flow, mute power generation can be realized without exhaust and pollution. Also, the motor can be started by a big-sized battery set A, and then the energy source is switched after about 2 m for power generation, so making it unnecessary to use more utility power.

On the other hand, this is a cost-effective power generation mode due to minimum cost and expenses in terms of maintenance, repair and management.

Alternatively, the water wheel 2 can be made of stainless steel or aluminium alloy; the generating capacity will exceed 500 kw when the diameter of the water wheel 2 is over 5 m, except for the disk body 21 which is molded at one time, the external wheel 24 can be designed in a way that it can be disassembled for convenient handling for example, during shipment, and then assembled by the technicians after arrival.

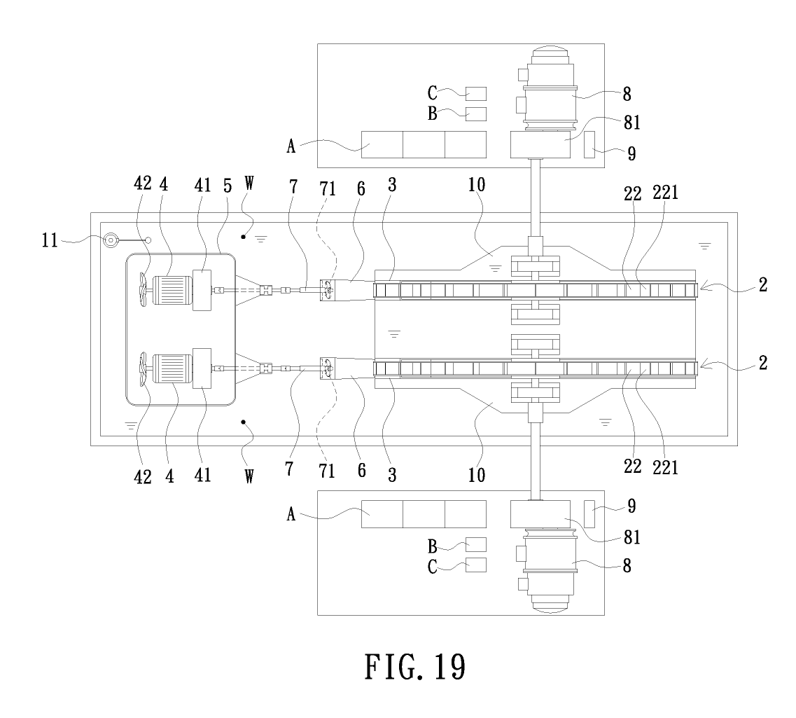

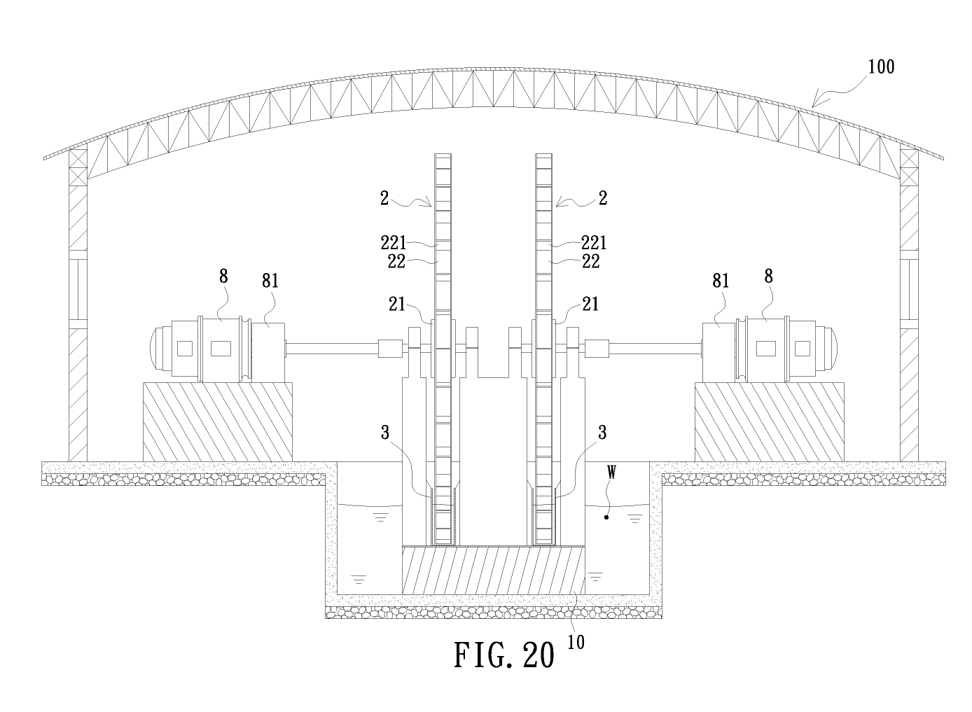

FIG. 19 depicts a top view of two power generating units, and FIG. 20 depicts an application view after a cover body is set additionally.

As disclosed in the figure above, the cover body 100 is either a sun-shading canopy, an industrial workshop or a cement building, which could mitigate the possible weathering influences against the power generating unit of the utility model.

Additionally, in order to meet the power generating demands, the motor 4 and water propeller 7 could be operated with two or even more sets of water wheels 2 and power generators 8 (depending on the generating capacity), hence the utility model can be operated more efficiently to address the shortage of energy source with bigger generating capacity.

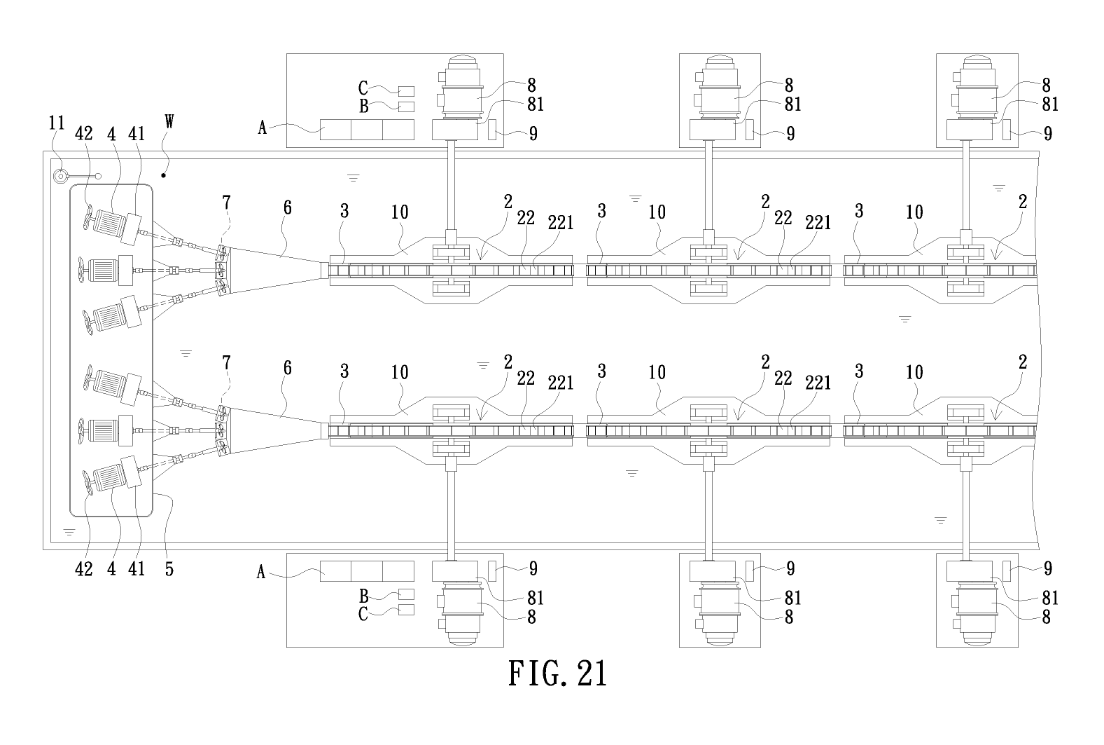

FIG. 21 depicts a top view of a multiple sets of power generating units, wherein water guide channels 3 in tandem can be combined with several water wheels 2, enabling power generation by several water wheels 2 in the following ways: water W is pushed by several water propellers 7 into the water guide channel 3 to yield high-speed impact on the first water wheel 2, then on the second and third ones in a rolling way, and finally flow into the pool 1 until flowing to the water guide channel 3; in this way, several water wheels 2 can be installed on the water guide channels 3 in tandem for cost-effective power generation.

If 110 kw is desired, 7.5 kw motor 4 runs at a rotation speed of 6000/rpm, and then decelerates to 2000/rpm through the connected reduction gearbox 41, so the torsion is tripled equivalent to that of 22.5 kw motor; the water propeller 7 is driven to feed a great amount of water W into the water compression tube 6 and the water guide channel 3, and yield high-speed impact on the water-retaining groove 22 of the water wheel 2 at a velocity of 25 km/h, and about 416 m/m, thus driving the water wheel of 6 m in dia. at a rate of 22.

The axle center of the water wheel 2 is connected with the acceleration gearbox 81 in front of the power generator 8; through planned multi-stage acceleration, the rotation speed is increased properly to propel the low-speed power generator 8, which could generate 110 kw minus 7.5 kw of the motor 4, with remaining 102.5 kw available.

Assuming that three sets of 15 kw motors 4 are used when the generating capacity is 1000 kw, the torsion is 2.5 times and gross torsion is changed to 112.5 kw when the rotation speed 6000/rpm is reduced to 2500/rpm, so a great amount of water will impact the water wheel 2 at high speed; similarly, the axle center is connected with the acceleration gearbox 81, so as to accelerate to properly propel the low-speed power generator 8, which could generate 1000 kw minus 45 kw of the motor 4, with remaining 955 kw available. The bigger generating capacity means lower power consumption of the motor 4.

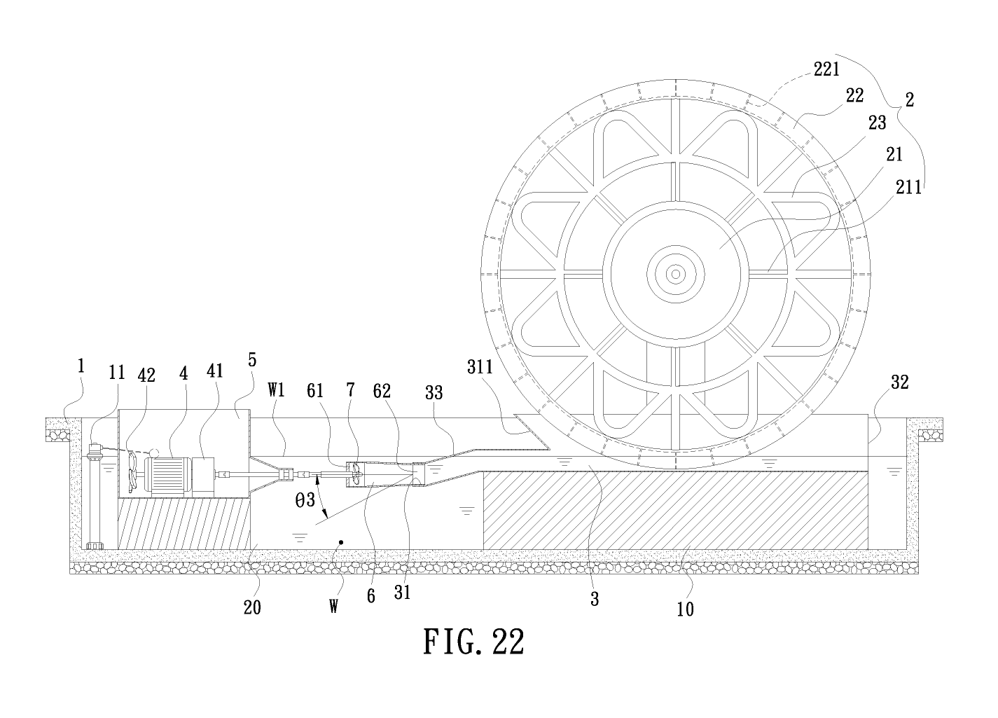

FIG. 22 depicts a sectional view of a special water guide channel, wherein it is characterized by that, the inlet tube 33 of the water guide channel 3 is extended obliquely below the water level W1 at an oblique angle of θ3, and then horizontally; the water compression tube 6 is aligned horizontally with the water guide channel 3, while the outlet 62 is connected with the inlet 31 of the water guide channel 3. Through such setting, the depth of water W and the interference against the flow velocity could be reduced, thus saving water resources and relevant cost.

In this preferred embodiment, when the water-retaining groove 22 of the external wheel 24 is perpendicular to the water surface W1, the water level only accounts for 50%˜80% of the depth of the water-retaining groove 22, thereby avoiding any interference of the water wheel 2 against the flow velocity.

1. A power generating unit, which comprising:
a pool filled with water;
at least a water wheel in the pool, and its lower end set below said water surface;
a water guide channel placed into the water under the water wheel, with an inlet tube extended at its front end and an open water outlet at its rear end; water can be guided from the inlet tube to the water guide channel, so as to impact the water wheel and then flow into the pool from the water outlet;
at least a motor set in the pool and kept at a spacing with said inlet tube;
a waterproofing motor housing set in the pool and capable of separating water from the motor;
a water compression tube located between said inlet tube and the motor, with its one end provided with an inlet set opposite to the motor and the other end with an outlet connected with the inlet of the inlet tube, and the diameter shrunk from the inlet to the outlet;
a water propeller located between the motor and the water compression tube, with its one end set far away from the inlet and coupled with the axle center of the motor, and the other end provided with a rotary fan set in the inlet of the water compression tube; water is guided from the inlet by the accelerated rotation of the water propeller, and then discharged from the outlet;
a power generator located out of the pool at one side of the water wheel's axle center and also coupled with the axle center; and
an electrical control box located out of the pool and electrically connected with the motor and the power generator to control their operation.

2. The device defined in claim 1, wherein a reduction gearbox for the motor is set between said motor and water propeller; moreover, the rear end of the motor is coupled with a radiator fan for the motor; an acceleration gearbox for the water wheel is set between said water wheel and power generator; the power generator is electrically connected with a control box, at least a big-sized battery set, at least a charger and at least a transformer set.

3. The device defined in claim 1, wherein a water wagon platform for positioning of the water guide channel is set in said pool; the water wagon platform is provided with left and right racks for supporting the spindle of the water wheel; a motor platform for positioning of the waterproofing motor housing is set at bottom of said waterproofing motor housing.

4. The device defined in claim 1, wherein said water wheel comprises: a disk body located at the axle center and coupled with the power generator, with several mating columns set circumferentially; an external wheel set around the disk body, butt-jointed with the mating columns of said disk body by several mating columns, and segregated into several water-retaining grooves by several breakwaters; and clamp plates screwed and connected between two mating columns and water-retaining groove.

5. The device defined in claim 1, wherein if two or more sets of said water propellers are arranged, every water propeller has an oblique angle with the axle center of the water compression tube, and the oblique angle is not the same.

6. The device defined in claim 1, wherein it is characterized by that: a water stop board capable of avoiding spillover of water is located at front end of said water guide channel correspondingly to the tangential direction of the water wheel; and the inlet tube is set under the front of the water stop board.

7. The device defined in claim 1, wherein it is characterized by that: the inlet tube of said water guide channel is extended obliquely below the water level, and then horizontally; the water compression tube is aligned horizontally with the water guide channel, while the outlet is connected with the inlet of the water guide channel.
